(19) United States
(12) Patent Application Publication
(10) Pub. No.: US 2013/0279011 A1
(43) Pub. Date: Oct. 24, 2013

(54) PRIVATE VIEW PROTECTOR

(71) Applicant: Akira Kubota, Gunma (JP)

(72) Inventor: Akira Kubota, Gunma (JP)

(73) Assignee: OKI ELECTRIC INDUSTRY CO., LTD., Tokyo (JP)

(21) Appl. No.: 13/978,646

(22) PCT Filed: Apr. 10, 2012
(86) PCT No.: PCT/JP2012/059755

§ 371 Date: Jul. 8, 2013

(30) Foreign Application Priority Data
May 20, 2011 (JP) 2011-113115

(51) Int. Cl. G02B 27/00

(52) U.S. Cl. CPC G02B 27/00
USPC 359/613

(57) ABSTRACT

An automatic transaction apparatus (12) has an input unit (18) for entering information and a private view protector (20) including an upper surface member (32) covering the input unit (18) from above. The private view protector (20) has an upper surface member (32) having tilted surfaces formed juxtaposionally thereon. The tilted surfaces are tilted more mildly as away from the operator (22) on the input unit (18) to form a slit member (24) having openings formed. Light fluxes (26, 28) from the input unit (18) are directed to the operator (22) so as not to reach a monitoring camera (14). That prevents the input unit from being visible from above while enabling the operator to view the input unit.

### TECHNICAL FIELD

The present invention relates to an information processing terminal apparatus such as an automatic transaction apparatus, and more particularly to a private view protector therefor.

### BACKGROUND ART

When transactions are conducted with an automatic transaction apparatus such as an automatic teller machine (ATM) or a cash dispenser, an end user, i.e. customer, is prompted to present an article such as a cash card or bank book identifying his or her account number and further to enter a pass code. Furthermore, when a credit card settlement is made with an information processing terminal device such as a PIN (personal identification number) pad, he or she is asked for entering the pass code of his or her credit card or the like.

Such entry of pass codes by end users involves a risk of leakage of pass codes to others. For example, there is a possibility that entry operations of end users may be viewed by other persons waiting behind in line. As a result, the input pass codes may become known to other persons. Furthermore, there is a possibility that input operations of end users may be shot by a monitoring camera installed on the ceiling for antitheft purposes, so that an input pass code may become known to a viewer of the images from the monitoring camera.

In order to prevent one from peeping at such input operations, for example, Japanese patent laid-open publication No. 2001-325665 proposes a key-hiding cover and a card pass code input pad equipped therewith. The key-hiding cover shields the side, front and upper portions of the input unit. The portion shielding the input unit from above has hexagonal holes cut like a honeycomb. In addition, Japanese patent laid-open publication No. 2008-287646 proposes an automatic transaction apparatus having an input unit whose lateral and upper sides are shielded by a cover, which is equipped with a reflecting mirror enabling the inner surface of the top portion to be viewed.

The cover of Japanese publication No. 2001-325665 prevents one from peeping from behind or beside the end user while allowing he or her to view the input unit and his or her hands during input operation. However, this cover cannot prevent a monitoring camera or the like installed on the ceiling from peeping from above the input unit. The cover of Japanese publication No. 2008-287646 can prevent peeping from behind and beside the end user and also from above the input unit whereas the cover puts the input unit and the hands out of his or her sight during input operation. Therefore, the end user must manipulate the keys while supposing where the keys are on the input unit, so that he or she may erroneously enter pass codes.

### SUMMARY OF INVENTION

It is therefore an object of the present invention to provide a novel and improved automatic transaction apparatus which prevents one from peeping at input operations while causing the input unit to be visible to the end user.

In the present specification, the term “information processing terminal apparatus” should broadly be interpreted so as to embrace not only information processing terminals such as PIN pads but also automatic transaction apparatus and information processing systems functioning as clients of a server.

An automatic transaction apparatus according to the present invention is featured by comprising an input unit for entering information and a private view protector having an upper surface member covering the input unit from above, the upper surface member having a plurality of tilted surfaces juxtaposed and an opening formed between adjacent ones of the plurality of tilted surfaces which form at least one set, the tilted surfaces being tilted more mildly as away from the operator of the input unit.

Also according to the present invention, a private view protector having an upper surface member covering an input unit entering confidential information is featured by the upper surface member being so disposed to have a plurality of tilted surfaces formed juxtapositionally and an opening region being formed between adjacent ones of the plurality of tilted surfaces forming at least one set, the tilted surfaces being tilted more mildly as away from the operator of the input unit, the opening region being open toward the operator.

According to the automatic transaction apparatus of the present invention, light flux from the input unit is directed toward the operator so as not to extend the light flux to a monitoring camera or another person located in the vicinity of the operator who is an end user. This allows the operator to view the input unit while preventing one from peeping during input operation.

### BRIEF DESCRIPTION OF THE DRAWINGS

The objects and features of the present invention will become more apparent from consideration of the following detailed description taken in conjunction with the accompanying drawings in which:

FIG. 1 is a view for use in describing a manipulation of an automatic transaction apparatus in an automatic transaction system with a monitoring function in accordance with the present invention;

FIG. 2 is a schematic perspective view of the automatic transaction apparatus of FIG. 1, as viewed from obliquely above;

FIG. 3 is an enlarged perspective view of a private view protector mounted on the automatic transaction apparatus of FIG. 1;

FIG. 4 is a cross-sectional view of the private view protector of FIG. 3, as viewed from the direction of the dot-and-dash arrows IV-IV;

FIG. 5 is a cross-sectional view for use in describing the view angle of an opening of the slits of the private view protector of FIG. 4;

FIGS. 6A to 6D are schematic representations of the relationship between the lean of tilted plate-like members of FIG. 5 and the view angle of the opening;

FIGS. 7A to 7D are schematic representations of the relationship between the length of the tilted plate-like members of FIG. 5 and the view angle of the opening;

FIGS. 8A to 8D are schematic representations of the relationship between the gap width formed by the tilted plate-like members of FIG. 5 and the view angle of the opening;

FIG. 9 is a schematic representation, like FIG. 1, showing differences in the view angle of the openings in the automatic transaction apparatus of FIG. 1;

FIG. 10 is a plan view, as viewed from above, showing an embodiment of the information processing terminal in accordance with the present invention;

FIG. 11 is a side elevation of the terminal device of FIG. 10, as viewed from below in the figure;

FIG. 12 is a side elevation of the terminal device of FIG. 10, when positioned at an angle as viewed from the right side of FIG. 10;

FIG. 13 illustrates the relationship between the horizontal angle and a protective angle in the terminal device of FIG. 10;

FIG. 14 is a perspective view of an alternative embodiment of the automatic transaction apparatus in accordance with the present invention, as viewed obliquely from the right side;

FIG. 15 is an enlarged view of the input unit, covered with a private view protector, of the automatic transaction apparatus of FIG. 14, as viewed obliquely from the right side in the figure;

FIG. 16 is a cross-sectional view of the input unit covered with the private view protector of FIG. 15, as viewed from the direction of the dot-and-dash arrows XVI-XVI; and

FIG. 17 is a view for use in describing the view angle of the openings formed in the private view protector of FIG. 14.

### BEST MODE FOR IMPLEMENTING THE INVENTION

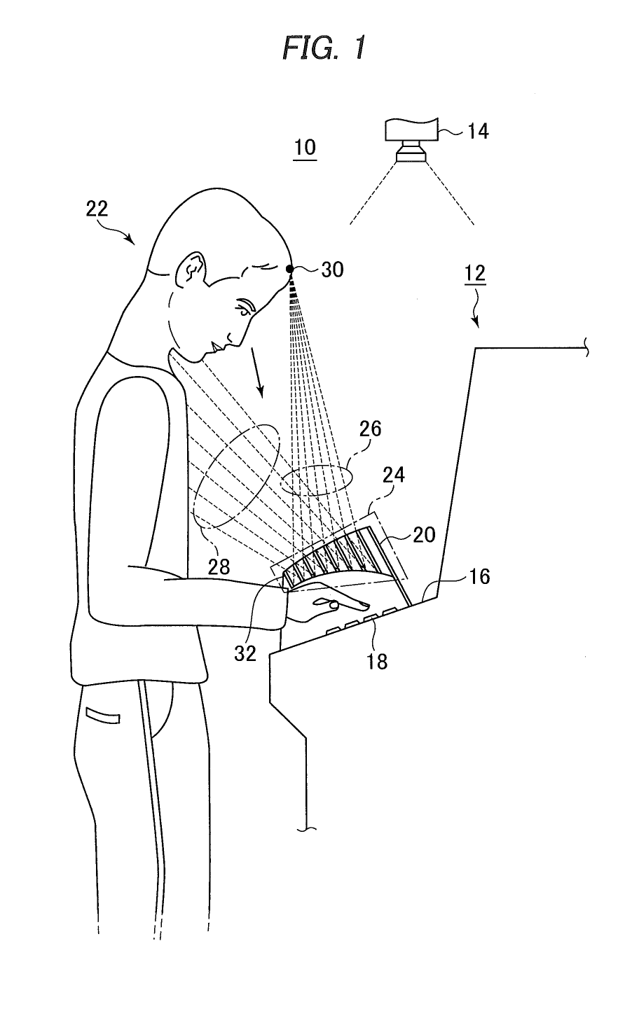

An embodiment of the automatic transaction apparatus according to the present invention will be described in detail with reference to the accompanying drawings. Referring to FIG. 1, the instant embodiment is an automatic transaction system 10, which has an automatic transaction apparatus 12 and a monitoring camera 14. The automatic transaction apparatus 12 includes an input unit 18 for entering information and a private view protector 20 having an upper surface member 32 shielding the input unit 18 from above. The private view protector 20 is structured such that the upper surface member 32 has a plurality of tilted surfaces formed appositionally to each other, each of which goes milder as it goes away from the operator 22 of the input unit 18, to form an aperture unit, or slit member, 24 in between the adjacent surfaces, whereby light fluxes 26 and 28 from the input unit 18 are directed to the operator 22 whereas they reach neither the monitoring camera 14 nor a third person located near the operator 22. It is therefore possible to prevent, for example, the monitoring camera 14 and the third person from peeping during input operations while causing the input unit 18 to be visible to the operator 22.

In the present specification and drawings, constituent elements having like functions or configurations are denoted by the same reference numerals and repeated description thereon is refrained from.

Well, during transactions using an automatic transaction apparatus such as an automatic teller machine (ATM) or cash dispenser or when a settlement is made using a plastic card such as a credit card at an information processing terminal such as a PIN (personal identification number) pad, the end user manipulates keys on the input unit in order to enter a pass code. If another person peeps at the key input operation, the pass code may become known to the other person. Therefore, in order to prevent pass codes from becoming known to others, the automatic transaction apparatus or information processing terminal is provided with a private view protector shielding the input unit thereof from above. This reduces the possibility that pass codes may become known to others.

Banks, shops and so on are often equipped with monitoring cameras on ceilings for antitheft purposes. In discussing the security in an environment where such monitoring cameras are installed, the monitoring cameras are adapted to shoot the input units of the automatic transaction apparatuses or information processing terminals so that the input operations of the end users are shot by the monitoring cameras. If other persons view such shot images, the pass codes of the end users may become known to other persons. Accordingly, private view protectors are required to take security measures under the monitoring camera environment, i.e. required to prevent peeping from above the input units.

On the other hand, the end user, when using an automatic transaction apparatus or information processing terminal, often hides the input unit with his or her head placed obliquely above the input unit against peeping during key input operation on the input unit of the apparatus. When the input operation is performed in such a posture, the end user may erroneously input unless he or she can view the input unit and his or her hands during input operation. Therefore, private view protectors are required not to interfere with the end users from viewing the input unit and his or her hands during input operations.

If a private view protector is disposed not to cover the input unit from above, the end user might view the input unit and his or her hands during input operation. However, it would be impossible to prevent peeping from above the input unit. Additionally, a private view protector adapted to simply cover the input unit from above could prevent peeping from above the input unit whereas simultaneously hiding the input unit and the hands from the end user during input operation so as to render an erroneous input operation.

The embodiments set forth below are the automatic transaction system 10 with monitoring function which can satisfy those requirements. As shown in FIG. 1, the automatic transaction system 10 with monitoring function is generally configured by the automatic transaction apparatus 12 and the monitoring camera 14.

The automatic transaction apparatus 12 has a function of authenticating an input pass code via a server to identify an end user 22, and being responsive to a request from the end user 22 to conduct a transaction such as deposit of cash, payment of cash, bank transfer, reception or balance inquiry. The automatic transaction apparatus 12 has an input unit consisting of a tilted console 16 on which plural input keys 18 are arranged in a certain pattern. The input keys 18 are covered by the private view protector 20. The private view protector 20 has functions of permitting the operator 22, who is an end user to manipulate the input keys, to view the input keys 18 and his or her hands, and of preventing the monitoring camera 14 from taking images of the input keys 18 when being manipulated. In order to implement this function, the private view protector 20 of FIG. 1 has the slit member 24 formed. The slit member 24 restricts light flux from under the protector 20 to light flux ranges 26 and 28 to allow the resulting light fluxes to exit. To clearly show how the outgoing optical beams accomplish visibility, FIG. 1 shows the private view protector 20 in cross section. The configuration of the cross section will be described in detail later. The light flux 26 converges, for example, onto a position 30 on the head of the operator 22. The point of convergence 30 is the deepest point reachable on the side of the operator 22. The light flux 26 does not reach farther than the deepest point 30. As is obvious from FIG. 1, the light flux 26 does not reach the monitoring camera 14. Therefore, the monitoring camera 14 cannot shoot the input unit 18.

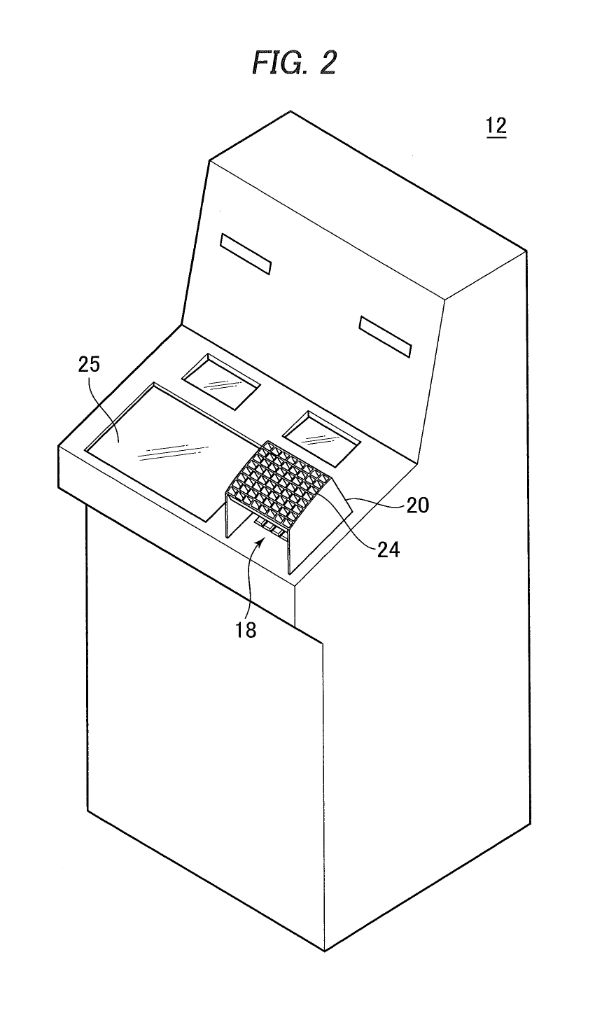

In the present embodiment, the monitoring camera 14 is fixed at a predetermined position, for example, on the ceiling of a booth, not shown, of the automatic transaction apparatus 12, and has a function of shooting the appearance of the operator therefrom. The monitoring camera 14 does not shoot the motion of the hands of the operator of the input unit 18 but a monitor screen 25, FIG. 2, of the apparatus 12 and how the operator performs manipulations such as opening and closing of the deposit/withdraw port for cash, insertion/ejection of a cash card, and so on.

As may be expected, although the console 16 of the automatic transaction apparatus 12 on which the input unit 18 is located has a tilted surface in FIG. 1, it may also be of an uninclined horizontal surface. The private view protector 20 is mounted according to the tilt of the surface of the console 16.

<Automatic Transaction Apparatus>

The embodiment of the automatic transaction apparatus in accordance with the present invention will be described with reference to FIGS. 2 to 9. The automatic transaction apparatus 12 is an information processing terminal device which may be installed, for example, in shops of financial institutions, retail stores such as convenience stores, public institutions or the like, and is connected, for example to a server system to automatically carry out procedural processing in response to a manipulation by the operator 22 in order to accomplish exchange of fund with parties under transaction. The automatic transaction apparatus 12 can process money deposit and payment transactions as well as nonmonetary transactions. One example of the automatic transaction apparatus 12 is an automatic teller machine. The operator 22 stands, as shown in FIG. 1, in front of the automatic transaction apparatus 12 and manipulates the input unit 18 and the control unit of the monitor screen 25 having a touch sensor function or the like, and the automatic transaction apparatus 12 carries out transactions with a party under transaction according to transaction details selected through manipulation by the operator 22.

The automatic transaction apparatus 12 is equipped, as shown in FIG. 2, with the input unit 18 and the private view protector 20. The input unit 18 has a function of entering information such as a pass code by input operation. For example, numerical keys, i.e. ten-key and symbol keys, are arranged on the input unit 18.

The private view protector 20 has a function of preventing one from peeping at input operation on the input unit 18. The private view protector 20 has the slit member 24 provided at its upper part. Of course, although the present embodiment is directed to the automatic transaction apparatus 12, the present invention may not be restricted to the specific embodiment but its technical features are also be applicable to information processing terminals such as PIN pads.

(Configuration of Private View Protector)

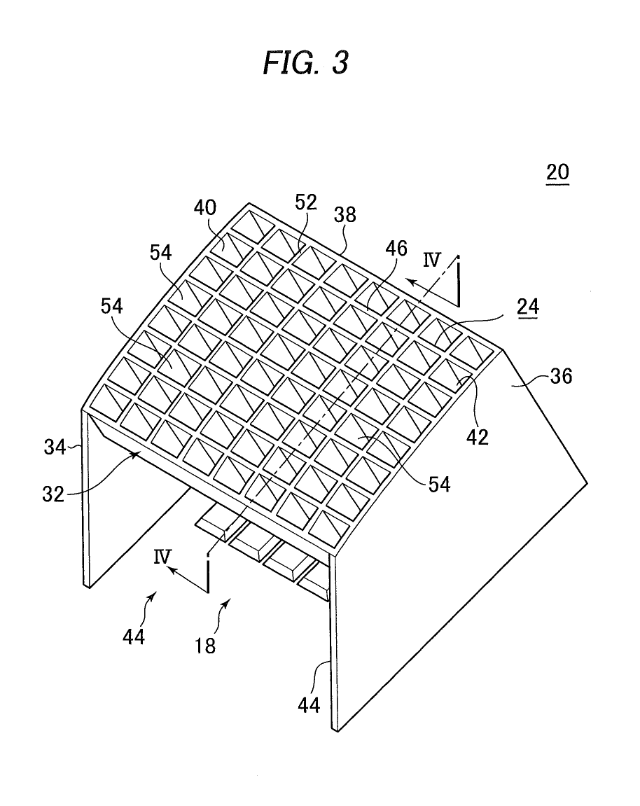

The private view protector 20 is, as shown in FIG. 3, made up of the upper surface member 32 and side surface members 34 and 36 such that it generally covers almost entirely the keys on the input unit 18 while forming an opening 44 and a manipulation space 48 for accepting a hand of the operator 22 to enable key manipulation. As described later, the upper surface member 32 is formed integrally with a rear surface 38 in the shape of slight arc as viewed on its side. The upper surface member 32 is coupled to the side surface members 34 and 36 at its opposite edges 40 and 42. Thus, the private view protector 20 has its upper and rear surfaces supported by the side surface members 34 and 36. The private view protector 20 has the opening 44 formed to permit insertion of a hand. The upper surface member 32 and side surface members 34 and 35 may be made of material optically opaque or optically semitransparent to such an extent that the input operation cannot clearly be viewed.

The upper surface member 32, and the side surface members 34 and 36 may not be clearly defined from each other as shown in FIG. 3, but, for example, their boundary portions may be formed into smooth curved edges.

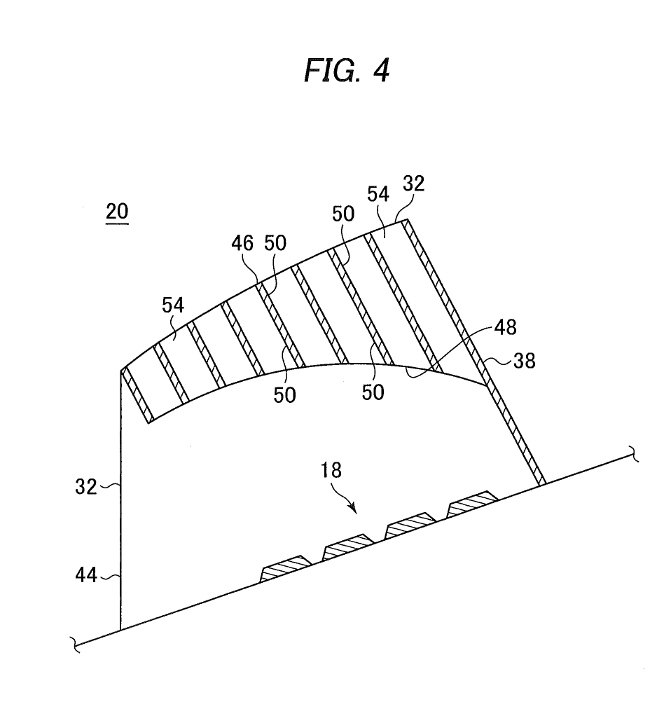

In order to further clarify the structure of the private view protector 20, a description will be made with reference to FIG. 4 showing a view broken away along break lines IV-IV in FIG. 3. The upper surface member 32 has plate-like members 46 disposed at an angle such that the whole length of the member 32 gradually increases as it goes deeper into the apparatus 12 from the opening 44, i.e. going away from the operator 22. This whole length can be regarded as the thickness of the upper surface member 32. The plate-like members 46 are referred to as “tilted plate-like members 46”. The members form the manipulation space 48 which shields the input unit 18 from above while enabling a hand and fingers to unrestraintly move for key input operations. The opening 44 is indicated with a leader 44, FIG. 3, the tip of which is indicative of the direction of the frontage through which a hand is inserted and the position of the opening. The manipulation space 48 is a space defined by the side surface members 34 and 36 and the rear surface 38 and by the upper surface member 32 covering the console 16. The tip of the leader line 48 in FIG. 4 points the inner surface boundary defining the upper edges of the space 48.

As can be seen from FIG. 4, the plural tilted plate-like members 46 are arranged like a louver. In other words, the tilted plate-like members 46 are so arranged that the angle of tilt with respect to the horizontal plane decreases gradually with going away from the operator of the input unit 18, i.e. deeper into the apparatus 12. Both primary planes of each tilted plate-like member 46 form tilted surfaces 50. In this way, the plural tilted surfaces 50 are juxtaposed on the upper surface member 32.

In the instant embodiment, although both surfaces 50 of each tilted plate-like member 46 are tilted, either of the rear and front surfaces of each member 46 may be tilted. The rear surface means a surface facing the opening 44 or directed leftward in FIG. 4. The front surface means a surface facing the rear surface 38 or directed rightward in FIG. 4. The plate-like members 46 and tilted surfaces 50 are flat in the present embodiment. However, the surfaces may be curved or uneven as long as the requirement holds that the angle of tilt decreases gradually with going away from the operator 22 on the input unit 18.

The upper surface member 32 is structured so that the adjacent tilted plate-like members 46 are spaced from each other and connected together by plate-like members 52 while maintaining the louver-like arrangement. From the viewpoint of the surfaces, it can also be said that the tilted surfaces adjacent to each other are connected together by the plate-like member 52, FIG. 3. The plate-like members 52 are referred to as “connecting plate-like members 52”. The tilted plate-like members 46 are arranged on the input unit 18 to extend in the transverse direction of the apparatus 12. The connecting plate-like members 52 are aligned on the input unit 18 to extend in the direction of depth of the apparatus 12. The upper surface member 32 thus forms the slit member 24 into a lattice-like structure together with the tilted plate-like members 46 and the connecting plate-like members 52.

The connecting plate-like members 52 may be positioned in number according to various sets of adjacent tilted plate-like members 46.

The slit member 24 of the upper surface member 32 is formed of plural openings 54, which are located between the adjacent tilted plate-like members 46, i.e. between the adjacent tilted surfaces 50. In the instant embodiment, the openings 54 lying between the adjacent tilted surfaces 50 are partitioned from each other by the associated connecting plate-like members 52.

Accordingly, the operator 22 can inserting his or her hand from the frontage 44 formed by the upper surface member 32 and side surface members 34 and 36 to manipulate the keys on the input unit 20.

(View Angle of Openings)

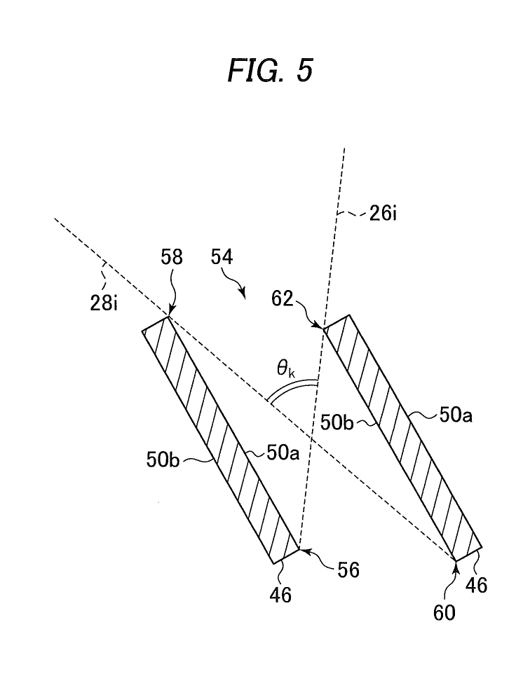

The view angle of the openings 54 in the slits 24 will be described with reference to FIG. 5. FIG. 5 shows the view angle of an opening 54 with the significant portion of a set of tilted plate-like members 46 adjacent to each other enlarged. The couple of adjacent tilted plate-like members 46 act as light-blocking means. The opening 54 is formed between the tilted plate-like members 46. The direction in which the interior is visible through the opening 54 is restricted by the plate-like members 46 aligned at an angle.

More specifically, the direction of visibility is a range of view angle θₖ formed between a light ray 26i contained in the light flux 26 and a light ray 28i contained in the light flux 28 in an open space between two opposite tilted surfaces, i.e. between the front surface 50a indicated by a line interconnecting the lower edge 56 to upper edge 58 and a rear surface 50b indicated by a line interconnecting a lower edge 60 to an upper edge 62. This means that light from under the private view protector 20 is blocked by the tilted plate-like members 46 and thus light is allowed to propagate only in directions contained in the view angle θₖ of the opening 54. Only light rays reaching the observer are visible.

The tilted surfaces 50 are inclined with the angles of tilt decreasing away from the operator 22 on the input unit 18. As a result, the view angle θₖ is not directed in the vertical direction but along the line of sight of the operator of the input unit 18. Accordingly, the private view protector 20 prevents peeping from above the input unit 18 by those openings 54 as shown in FIG. 1 while enabling the operator 22 on the input unit 18 to view the input unit 18 and his or her hands during input operation.

Furthermore, in order to implement the private view protector 20 that is anti-peeping from above and optimum to visibility to the operator 22 on the input unit 18 and his or her hands during input operation, some or all of the openings 54 are made different, for example, in magnitude or orientation of the view angle θₖ.

Note that the magnitude of the view angle θₖ is the value of angle θₖ, and the orientation of the view angle θₖ is, for example, the direction of a line, not shown, at an angle θₖ/2 that is the center of the angle of θₖ. As one example, in a case where the camera 14 is located immediately overhead, i.e. in the direction of the ceiling of the booth, the openings 54 are arranged such that openings 54 positioned remoter from the operator 22 may have the view angles thereof not directed just overhead whereas openings 54 positioned closer to the operator 22 may have the view angles thereof directed toward overhead to some extent.

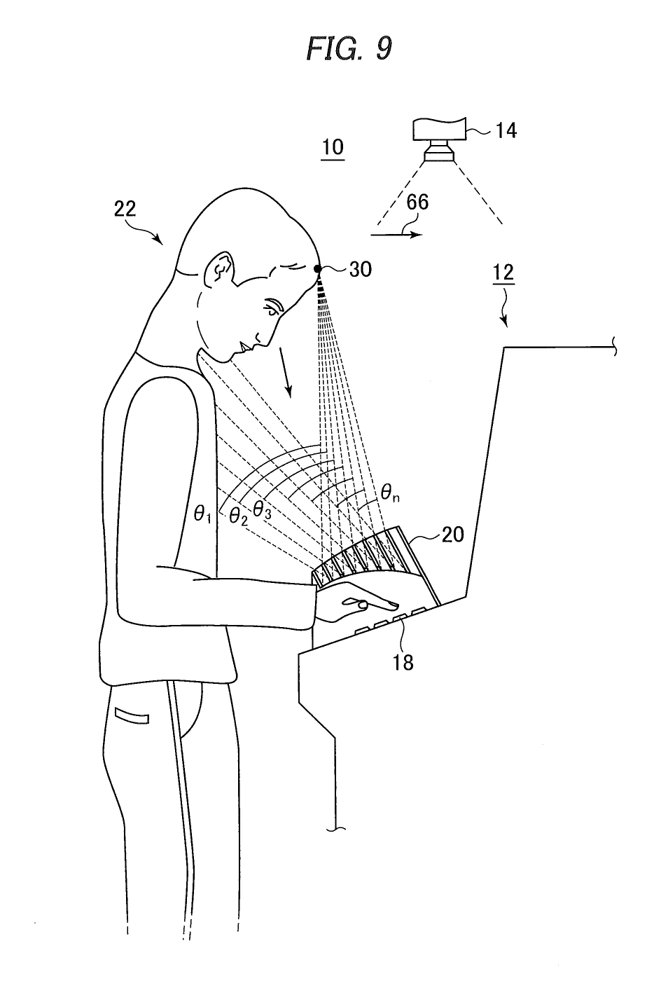

As a consequence, when the operator 22 on the input unit 18 postures with his or her head located above the private view protector 20 as shown in FIG. 1 and FIG. 9, described later, the operator 22 can view the interior under the private view protector 20 through all the openings 54 including the openings positioned closest to him or her, and simultaneously shield with his or her head and part of his or her body the view angles of all the openings 54 including the openings positioned farthest from him or her.

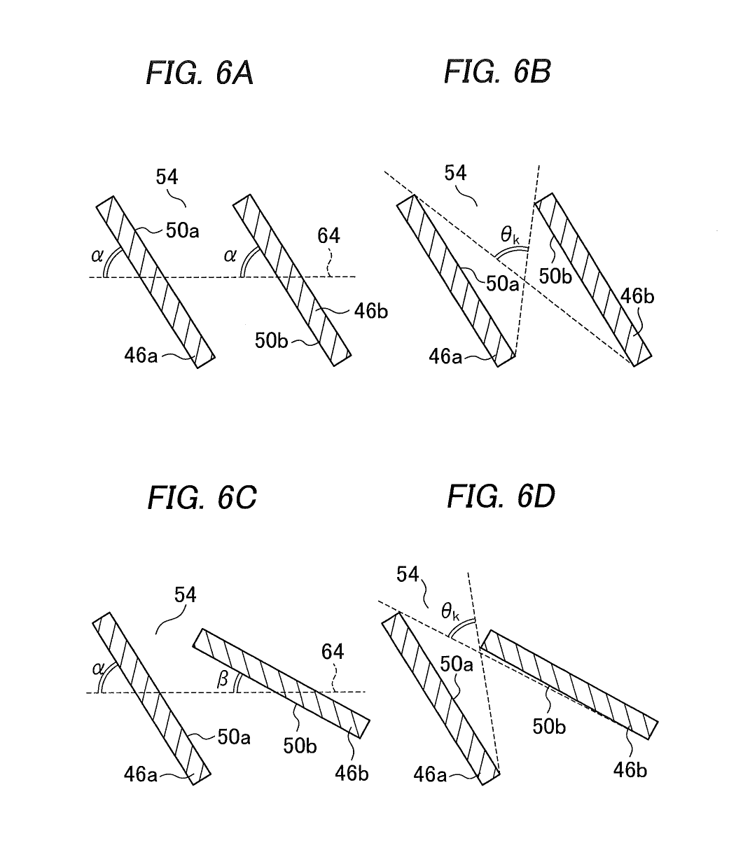

In order that the openings 54 are made difference in magnitude or orientation of the view angle θₖ opening by opening, some or all of the tilted surfaces 50 may be different, for example, in tilt angle. A case where the tilted plate-like members 46a and 46b are arranged at the same tilt angle in parallel to each other is shown in FIGS. 6A and 6B. A case where they are arranged in nonparallel to each other is shown in FIGS. 6C and 6D. In the parallel arrangement, FIG. 6A, the tilted plate-like members 46a and 46b are set at a tilt angle α with respect to the horizontal 64. In the nonparallel arrangement, FIG. 6C, the tilted plate-like members 46a and 46b are set at tilt angles α and β with respect to the horizontal 64. The magnitudes of these tilt angles have the relation: α>β. When the tilt angle of the tilted plate-like member 46b varies, the magnitude and orientation of the view angle θₖ of the opening 54 change accordingly.

Specifically, when the tilt angle β of the tilted plate-like member 46b is smaller than the tilt angle α, the view angle θₖ is smaller than in the case of parallel arrangement and the view angle θₖ is deviated to the operator 22 from overhead or the ceiling. In this way, some or all of the tilted plate-like members 46 are formed differently in tilt angle to thereby make those openings 54 different in magnitude or orientation of the view angle θₖ.

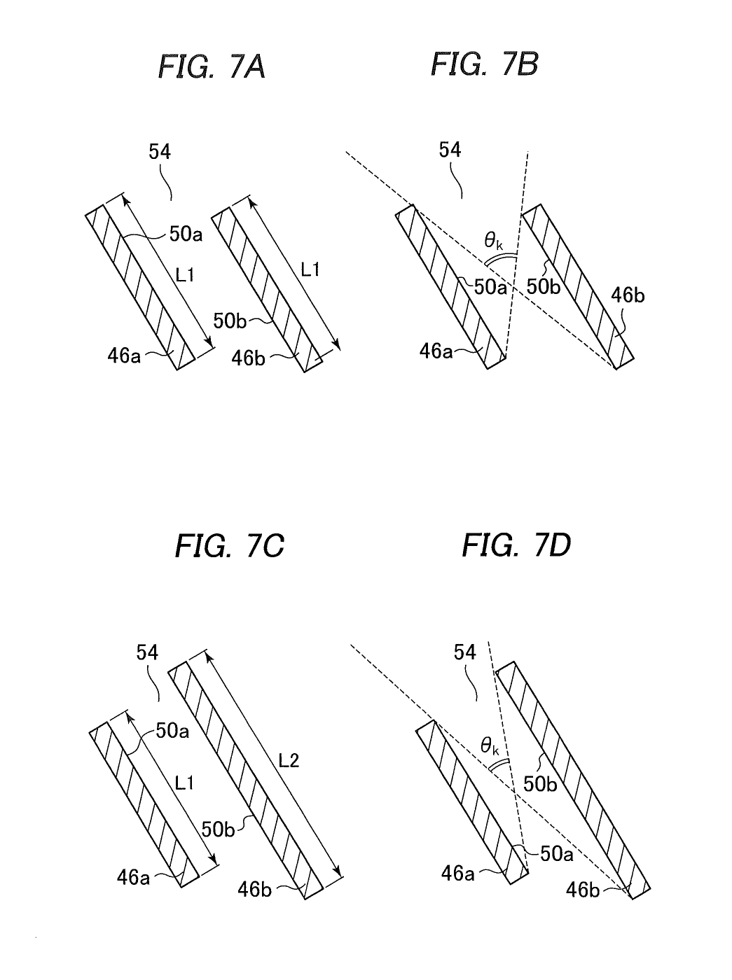

In order that the magnitude or orientation of the view angle θₖ is made different specifically to the openings 54, some or all of the tilted plate-like members 46 may be made different, for example, in direction of tilt and length. The tilted plate-like members 46a and 46b are formed at the same tilt angle in parallel to each other. As shown in FIGS. 7A and 7B, the tilted plate-like members 46a and 46b are both set to have its length L1. The magnitude and orientation of the view angle θₖ of the opening 54 satisfies the relationship shown in FIGS. 6A and 6B. As shown in FIGS. 7C and 7D, the tilted plate-like members 46a and 46b are set to have lengths L1 and L2, respectively. The set lengths have the relationship: L1<L2. In this way, when the tilted plate-like members 46a and 46b are varied in length, the magnitude and orientation of the view angle θₖ of the openings 54 vary as shown in FIGS. 7C and 7D.

More specifically, when the length L2 of the tilted plate-like member 46b is greater than the length L1, the view angle θₖ is smaller than when the length is set to the same length L1, and the orientation of the view angle θₖ is deviated toward the operator 22 from overhead or the ceiling. In this way, some or all of the plate-like members 46 are formed differently in length to thereby make those openings 54 different in magnitude or orientation of the view angle θₖ.

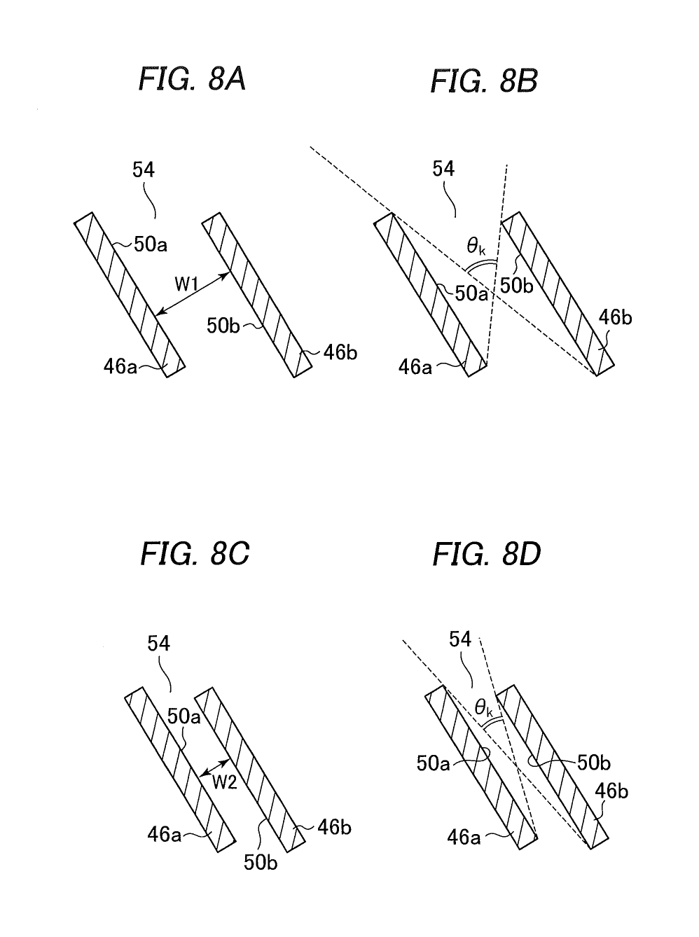

In order that the magnitude and orientation of the view angle θₖ vary specifically to the openings 54, some or all of the tilted plate-like members 46a and 46b may be different between adjacent ones, for example, in a gap width W formed by the tilted surfaces 50a and 50b. The gap width W is a distance or spacing, for example, between the opposite tilted surfaces 50a and 50b in a direction normal to the respective surfaces. As shown in FIGS. 8A and 8B, the tilted plate-like members 46a and 46b are different in gap width W even under the condition of the same length in the parallel arrangement. When the tilted plate-like members 46a and 46b have the gap width W1 shown in FIGS. 8A and 8B, they bear the same relationship as FIGS. 6A and 6B. The tilted plate-like members 46a and 46b have the gap width set to W2 in FIGS. 8C and 8D. The set gap width has the relationship: W1>W2. When the tilted plate-like members 46a and 46b vary in gap width in this way, the magnitude and orientation of the view angle θₖ of the openings 54 vary as shown in FIGS. 8C and 8D.

More specifically, when the gap width of the tilted plate-like member 46b is reduced, the magnitude of the view angle θₖ decreases, and the view angle θₖ is deviated toward the operator 22 from overhead or the ceiling. Some or all of the tilted plate-like members 46 are formed differently in this way between adjacent ones in gap width to thereby make those openings 54 different in magnitude and orientation of the view angle θₖ.

As a matter of course, the tilted plate-like members 46 may be configured differently in any two or more of individual tilt angles, individual lengths in longitudinal or tilted direction, and gaps between the adjacent tilted surfaces 50a and 50b to thereby make different the magnitude and orientation of the view angle θₖ of the openings 54.

(Example of Manipulation)

Then, it is shown in FIG. 9 how some or all of the openings 54 are made different in magnitude or orientation of the view angle θₖ or θₙ to prevent light from leaking from under the private view protector 10 toward overhead or the ceiling while facilitating the operator 22 to view the input unit 18 and his or her hands during input operation. The tilted plate-like members 46 are partly or entirely different in length.

The openings 54 are so designed that the tilt angle θₖ decreases and the orientation of the tilt angle θₖ deviates more from the direction of the overhead, for example, as far away from the operator 22. In other words, the tilt angle θₖ of each opening portion 54 increases and the orientation of the tilt angle θₖ comes closer to the vertically upward direction as it comes closer to the operator 22. As a result, light having come from under the private view protector 20 to pass the openings 54 does not proceed farther than the deepest position 30 in the direction of arrow 66 but sufficiently to the eyes of the operator 22.

If light from under the private view protector 20 is spread toward the operator 22, the body of the operator 22 prevents the light from proceeding father toward his or her back. The private view protector 20 can thus prevent peeping from above the input unit 18 while permitting the operator 22 to view the input unit 18 and his or her hand during input operation.

If the private view protector 20 has its side surface members 34 and 36 made of optically opaque or semitransparent material as described earlier, then it can shield against peeping by another person from, for example, obliquely behind or beside the operator 22.

Furthermore, the connecting plate-like members 52 included in the upper surface member 32 also prevent one from peeping from obliquely behind or beside the operator 22 through the openings 54, and therefore input operation can be hidden because the connecting plate-like members 52 block light from under the private view protector 20.

In addition, the frontage 44 of the private view protector 20 is set at a level at which the operator 22 can move his or her hand while inserted. The private view protector 20 has its inside space sufficiently large to permit key manipulations. During key manipulations, the palm of the operator 22 may appropriately hide the input keys, and thus the private view protector 20 can protect the keys against peeping from the frontage 44.

<Information Processing Terminal>

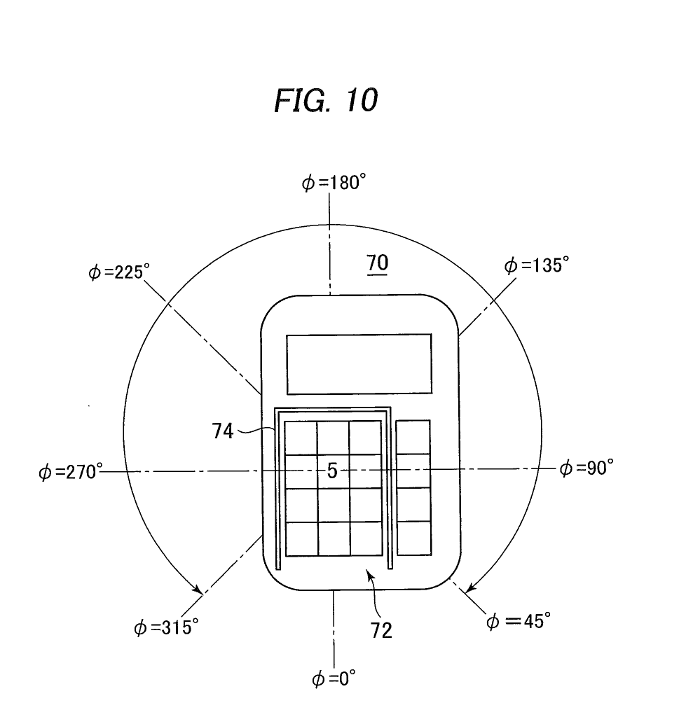

A terminal device 70 will be described as an embodiment of the information processing terminal in accordance with the present invention with reference to FIGS. 10, 11 and 12. The terminal device 70, as shown in FIG. 10, has an input unit 72 and a private view protector 74.

FIG. 10 shows azimuths centered on a horizontal plane about a specific key of the input unit 72 of the terminal device 70, i.e. angle φ on the horizontal plane. The specific key may be a numerical key “5” at the center of the ten-key, for example. This angle φ on the horizontal plane is referred to as “horizontal angle”. For the horizontal angle φ, 6 o'clock, 3 o'clock, 0 o'clock and 9 o'clock on tke clock in a counterclockwise direction are set to 0°, 90°, 180° and 270°, respectively.

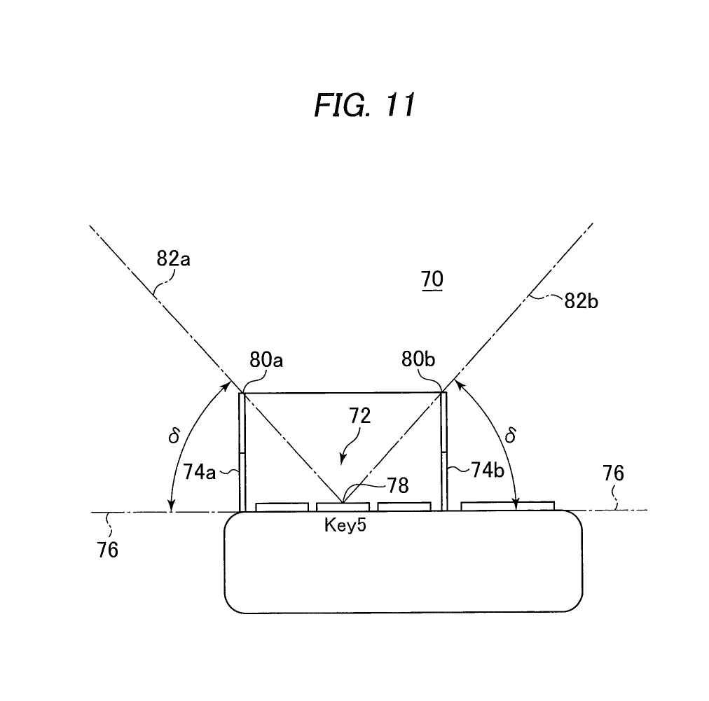

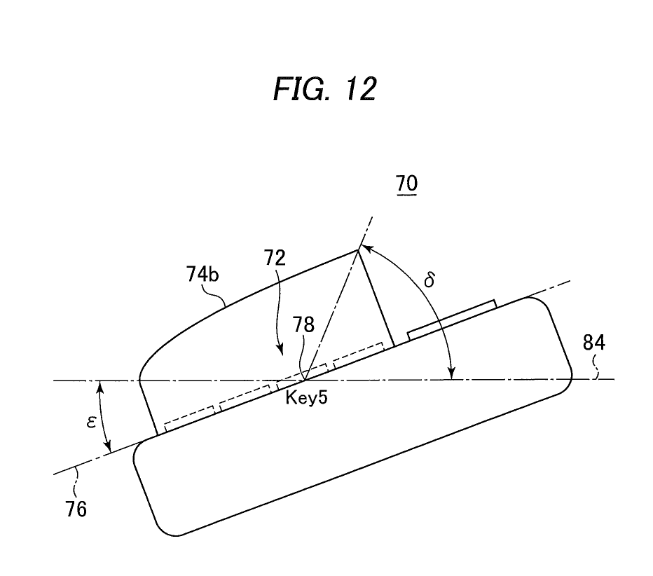

The private view protector 74, as shown in FIG. 11, has upright side surface plates 74a and 74b standing to have the heights thereof which can hide the ten-key from the eyes of other persons. The height of the side surface plate 74a is defined by an angle δ that is formed by an upper edge 80a of the side surface plate 74a with respect to a horizontal plane 76 of the key unit as viewed from the center 78 (position of key “5”), i.e. an angle of elevation of a dot-and-dash line 82a, connecting the center 78 to the upper edge 80a of the side surface plate 74a, formed with respect to the horizontal plane 76 of the unit. Also, the height of the side surface plate 74b on the opposite side is defined by an angle δ formed by an upper edge 80b of the side surface plate 74b with respect to the horizontal plane 76 of the unit as viewed from the center 78, i.e. an angle of elevation of a dot-and-dash line 82b, connecting the center 78 to the upper edge 80b of the side surface 74b relative to the horizontal plane 76 of the unit. The angle defining the heights of the side surface plates 74a and 74b is referred to as “protective angle”. A case in which the terminal device 70 is installed at an angle of ε to an installation reference plane 84 is shown in FIG. 12.

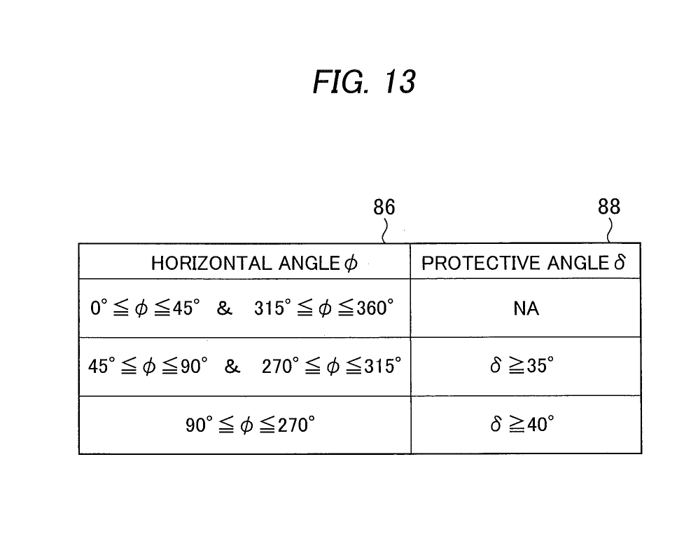

With reference to these FIGS. 10, 11 and 12, it will be discussed how to set the protective angle δ formed according to the horizontal angle φ by the private view protector 70. The requirements to be satisfied are shown in FIG. 13. In the ranges where the horizontal angle (86) satisfies the relationship 0°≦φ≦45° and 315°≦φ≦360°, the input unit 72 is hidden by the body of the operator 22, and thus peeling is failed. Accordingly, the protective angle δ (88) is dispensed with (NA). In the angular ranges where the horizontal angle (86) satisfies the relationship 45°≦φ≦90° and 270°≦φ≦315°, the body of the operator 22 may partially block but partially allow peeping. In that case, the protective angle δ (88) is required to be equal to 35° or more. Where the terminal device 70 is tilted as shown in FIG. 12, the side surface plates of the private view protector 74 have preferably the parts thereof, upper than the center 78 of the input unit 72, positioned higher than the remaining parts thereof. In the angular range where the horizontal angle (86) satisfies the relationship 90°≦φ≦270°, the protective angle δ (88) is required to be equal to 40° or more. Where the terminal device 70 is tilted at angle ε>0, the side surface plates of the private view protector 74 may have the parts thereof, upper than the center 78 of the input unit 72, positioned lower than the remainingparts thereof.

### Alternative Embodiment

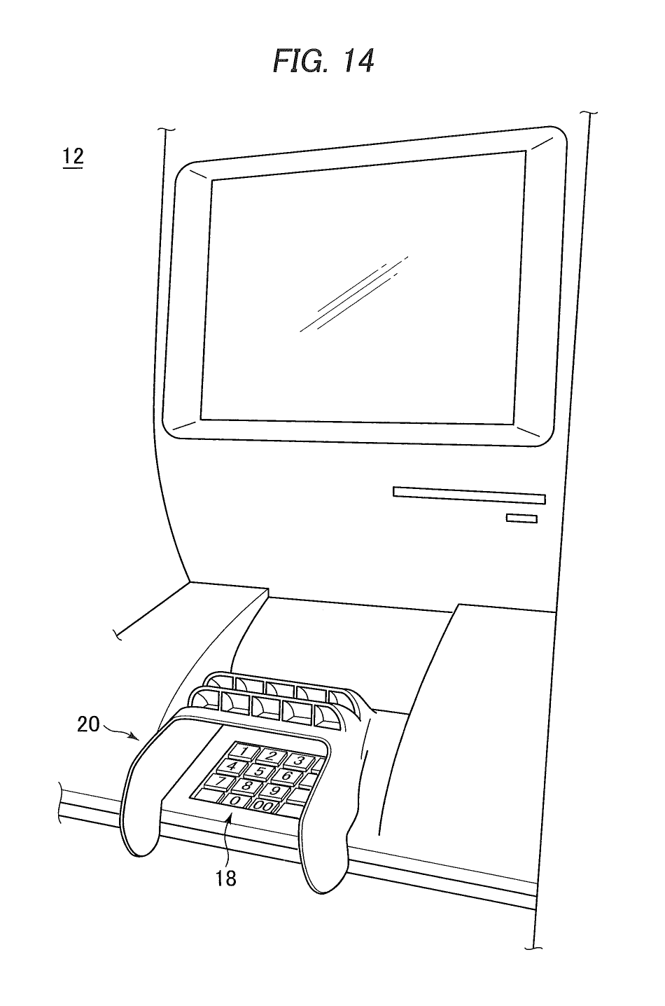

Well, a description will be made, with reference to FIG. 14, on an alternative embodiment of the automatic transaction apparatus in accordance with the present invention to which the terminal device 70 satisfying the requirement for the protective angle δ thus discussed. The automatic transaction apparatus 12 includes the input unit 18 and the private view protector 20 as shown in FIG. 14. As described on the earlier described embodiment, the automatic transaction apparatus 12 has the function of permitting the operator 22, not shown in FIG. 14, to enter information such as a pass code through input operation on the input unit 18. The private view protector 74 is a constituent element having the function of shielding the input operation on the input unit 18 from peeping.

(Configuration of Private View Protector)

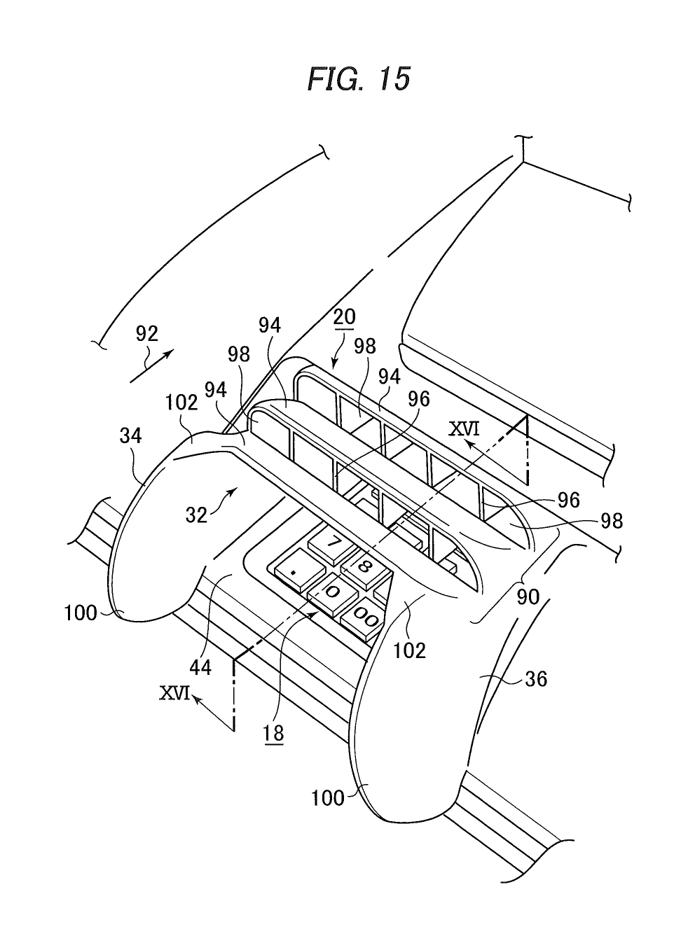

As shown in FIG. 15, the private view protector 20 has an upper surface member 32 covering the input unit 18 from above and side surface members 34 and 36 supporting the upper surface member 32 by their respective side surfaces, all of which are formed integrally with each other. The upper surface member 32 is joined to the upper edges of the side surface members 34 and 36 at its respective side edges. The upper surface member 32 is thus supported to the side surface members 34 and 36 to almost generally cover the input unit 18. The private view protector 20 allows the operator to insert and move his or her hand, not shown, through the frontage 44 formed by the upper surface member 32 and side surface members 34 and 36. The operator can depress and manipulate the input keys arranged on the input unit 18 without difficulty notwithstanding the private view protector 20 being disposed. The upper surface member 32 and side surface members 34 and 36 may be optically opaque or semitransparent to such an extent that input operation of the input unit 18 is invisible.

The upper surface member 32 and the side surface members 34 and 36 may be defined from each other much more clearly than shown in FIG. 15, or their boundary portions may be formed into smoother curved edges.

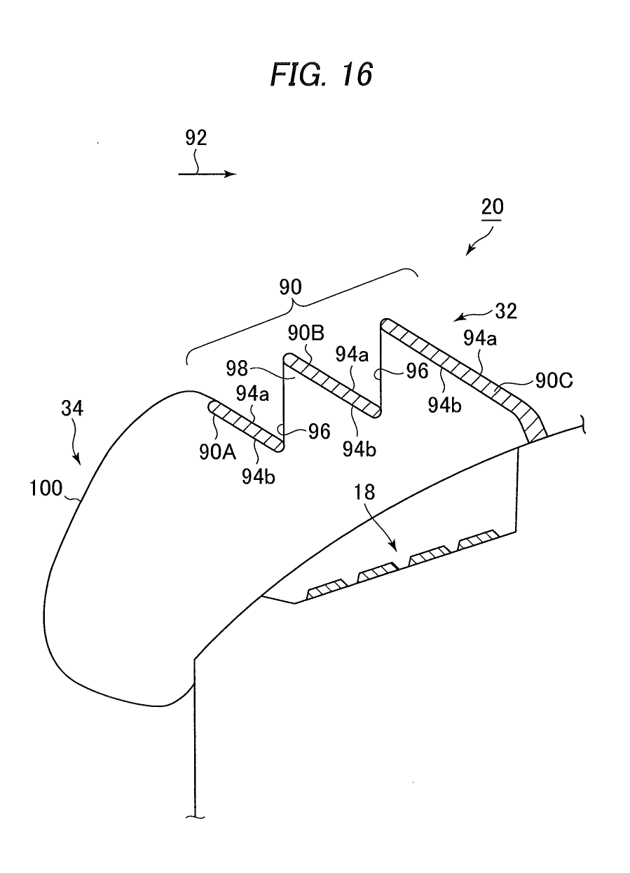

The wavy members 90, the significant part of the private view protector 20, are shown in FIG. 16 in an enlarged representation taken in the direction of the dot-and-dash arrows XVI-XVI in FIG. 15. The upper surface member 32 includes the wavy members 90 (90A, 90B and 90C) having wavy, uneven cross sections. Each wavy member 90 includes a tilted surface 94 that is tilted such that the tilt angle decreases as it goes away from the operator of the input unit 18, i.e. going in the direction of arrow 92. In the present embodiment also, plural tilted surfaces 94 are thus formed juxtapositionally on the upper surface member 32 as with the embodiment described earlier.

The tilted surfaces 94 are, as shown in FIG. 16, directed to both a front surface 94a and a rear surface 94b opposite to the front surface or to either one of them. In the instant embodiment, the tilted surfaces 94 are flat. However, they may be curved or uneven so long as they are tilted such as to become lower in the direction of the arrow 92. Additionally, there is, of course, no restriction imposed on the number of concavities and convexities of the wavy members 90.

Referring back to FIG. 15, the upper surface member 32 includes plate-like members 96 interconnecting adjacent ones of the tilted surfaces 94 to each other. The plate-like members 96 are referred to as “connecting plate-like members”. The connecting plate-like members 96 may be so provided correspondingly in position and number to the combinations of adjacent tilted surfaces 94.

The upper surface member 32 includes openings 98 formed between adjacent ones of the tilted surfaces 94. The adjacent tilted surfaces 94 are coupled together by the connecting plate-like members 96. Thus, the defined plural openings 98 are formed in parallel to each other. More specifically, the openings 98 are oriented on the side of the surfaces of the wavy members 90 that are opposite to the tilted surfaces 94, i.e. on the side of the rear surfaces facing the operator of the input unit 18. The outermost ones of the openings 98 are smaller in area, for example, than the remaining openings 98.

The side surface members 34 and 36, as shown in FIGS. 15 and 16, have protrusions 100 projecting from the upper surface member 32 toward the operator in a direction reverse to the arrow 92. The upper surface member 32 continues to the protrusions 100 by joining members 102.

(View Angle of Openings)

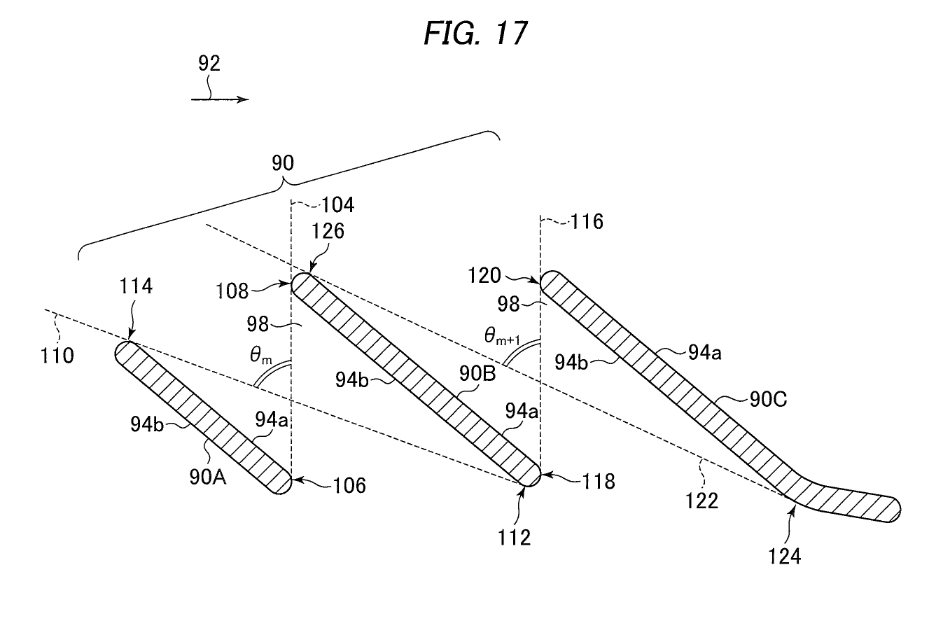

Positions where the interior below the private view protector 20 is visible through the openings 98 will be described with reference to FIG. 17. On the upper surface member 32, the three wavy members 90A, 90B and 90C are arranged in parallel and juxtapositionally. The wavy members 90A, 90B and 90C restrict the view angle of the openings 98. For example, when the tilted front surface 94a of the wavy member 90A faces the tilted rear surface 94b of the wavy member 90B, a line of sight 104 passes the lower edge 106 of the wavy member 90A and the upper edge 108 of the wavy member 90B to be restricted by the wavy members 90A and 90B. A line of sight 110 passes the lower edge 112 of the wavy member 90B and the upper edge 114 of the wavy member 90A to be restricted by the wavy members 90A and 90B. As this result, the view angle of the openings 98 formed by the wavy members 90A and 90B is restricted to angle θₘ on a plane parallel to the sheet of FIG. 17.

Similarly, when the tilted front surface 94a of the wavy member 90B faces the tilted rear surface 94b of the wavy member 90C, a line of sight 116 passes the lower edge 118 of the wavy member 90B and the upper edge 120 of the wavy member 90C to be restricted by the wavy members 90B and 90C. A line of sight 122 passes the lower edge 124 of the wavy member 90C and the upper edge 126 of the wavy member 90B to be restricted by the wavy members 90B and 90C. As this result, the view angle of the openings 98 formed by the wavy members 90B and 90C is restricted to angle θₘ₊₁ on the plane parallel to the sheet of FIG. 17.

In other words, light from under the private view protector 20 is blocked by the tilted surfaces 94, so that the light propagates only in directions contained in the view angle θₘ or θₘ₊₁ of the openings 98.

It can be said that the private view protector 20 thus structured sufficiently satisfies the conditions for the protective angle δ shown in FIG. 13.

Since the tilted surfaces 94 are inclined at tilt angles decreasing as away from the operator of the input unit 18, the view angles θₘ and θₘ₊₁ indicating the angles of openings are not directed to the just above or ceiling but in a direction reverse to the arrow 92, i.e. directed toward the line of sight of the operator of the input unit 18. Accordingly, the private view protector 20 having the openings 98 thus arranged prevents peeping from above the input unit 18 while enabling the operator of the input unit 18 to view the input unit 18 and his or her hands during input operation.

As with the earlier-described embodiment, in order to attain the optimum private view protector 20 preventing peeping from above and facilitating the operator in viewing the input unit 18 and his or her hand during input operation, some or all of the openings 98 of the private view protector 20 may be different in magnitude or orientation of the view angle. In the instant alternative embodiment, the view angles are set to θₘ and θₘ₊₁. The private view protector 20 may not be restricted to the specific structure of the instant alternative embodiment, but may be arranged, as with the earlier-described embodiment, in such a fashion that the openings are different in tilt angle of the tilted surfaces 94, length in the direction of tilt of the tilted surface 94, or gap width between adjacent tilted surfaces 94 to thereby make the openings 98 different in magnitude or orientation of the view angle. The tilt angles and lengths in the direction of tilt of the tilted surfaces 94, and gap widths can be made different by changing parameters such as the sizes, shapes and/or spacing of the concavities and convexities of the wavy members 90.

The side surface members 34 and 36 of the private view protector 20, which have the protrusions 100 formed, can also shield against peeping, for example, from obliquely behind or beside the operator. Even if the edge of the upper surface member 32 facing the operator is so high as to attain a broader frontage through which the operator can easily insert his or her hand under the private view protector 20, the protrusions 100 can prevent peeping from obliquely behind or beside the operator.

The joining members 102 joined to the protrusions 100 can hide part or entirety of the input unit 18 as shown in FIG. 15 also when one attempts to peep at the input unit 18 obliquely from above the protrusions 100.

The connecting plate-like members 96 can hide input operation also when one tries to peep into the openings 98 from obliquely behind or beside the operator because the connecting plate-like members 96 blocks light from under the private view protector 30.

The openings smaller in area located at the extreme edges of the upper surface member 32 and the remaining openings, larger in area, facilitate the operator in viewing the input unit 18 and his or her hand during input operation while rendering the input unit 20 invisible from obliquely behind or beside the operator of the input unit 18.

Although the embodiments described so far are exemplarily directed to automatic transaction apparatuses, the present invention may not be restricted to those embodiments. The private view protector may be disposed so as to cover a terminal device. Furthermore, the private view protectors may not be mounted in advance on automatic transaction apparatuses or information terminal devices, but may be in a detachable form, for example.

The embodiments have been described independently of each other. However, the constituent elements can be combined at will beyond those embodiments. As one example, the joining members 102 and protrusions 100 of the alternative embodiment may be included in the private view protector 20 of the terminal device 70. Besides, the constituent elements can be combined in various ways.

The entire disclosure of Japanese patent application No. 2011-113115 filed on May 20, 2011, including the specification, claims, accompanying drawings and abstract of the disclosure, is incorporated herein by reference in its entirety.

While the present invention has been described with reference to the particular illustrative embodiments, it is not to be restricted by the embodiments. It is to be appreciated that so-called those skilled in the art can change or modify the embodiments without departing from the scope and spirit of the present invention.

1. An automatic transaction apparatus comprising:
an input unit for entering information; and
a private view protector having an upper surface member covering said input unit from above,
wherein said upper surface member has a plurality of tilted surfaces juxtaposed with each other, and
an opening formed between adjacent ones of said tilted surfaces which form at least one set of tilted surfaces,
said tilted surfaces having respective tilt angles that decrease as away from an operator of said input unit.

2. The apparatus in accordance with claim 1, wherein said opening forms a view angle relative to said input unit, the view angle being different in magnitude or orientation along a depthwise direction of said apparatus between some or all of said openings.

3. The apparatus in accordance with claim 1, wherein said plurality of tilted surfaces are different in the tilt angle between some or all of said tilted surfaces.

4. The apparatus in accordance with claim 1, wherein said plurality of tilted surfaces are different in length in a direction of tilt between some or all of said tilted surfaces.

5. The apparatus in accordance with claim 1, wherein said opening is formed between adjacent ones of said tilted surfaces forming two or more sets of tilted surfaces, said adjacent tilted surfaces of the two or more sets being different in gap width formed by the tilted surfaces between some or all of said tilted surfaces.

6. The apparatus in accordance with claim 1, wherein said private view protector comprises side surface members that cover both sides of said input unit.

7. The apparatus in accordance with claim 6, wherein said side surface members comprise a protrusion projecting toward the operator of said input unit relative to said upper surface member.

8. The apparatus in accordance with claim 7, wherein said upper surface member comprises a joining member extending to be joined to said protrusion.

9. The apparatus in accordance with claim 1, wherein said upper surface member comprises at least one first plate-like member connecting together the adjacent tilted surfaces forming the at least one set,
the adjacent tilted surfaces forming the at least one set containing said openings in plural in between, said openings being partitioned from each other by said first plate-like member.

10. The apparatus in accordance with claim 9, wherein, among said plurality of openings, openings located at both extremes are smaller in area than remaining ones of said plurality of openings.

11. The apparatus in accordance with claim 1, wherein said upper surface member comprises a second plurality of plate-like members arranged in a form of louver,
said second plurality of plate-like members being tilted at respective tilt angles that decrease as away from the operator of said input unit,
said plurality of tilted surfaces being surfaces of said second plurality of plate-like members,
said opening being located between adjacent ones of said second plurality of plate-like members which form the at least one set.

12. The apparatus in accordance with claim 1, wherein said upper surface member comprises a wavy member having wavy uneven portions,
the wavy uneven portions being more tilted farther from the operator of said input unit to form said plurality of tilted surfaces,
said opening being in said wavy member to open toward the operator of said input unit.

13. An information processing terminal comprising:
an input unit for entering information; and
a private view protector having an upper surface member covering said input unit from above;
wherein said upper surface member has a plurality of tilted surfaces arranged juxtapositionally to form an opening region between adjacent ones of said plurality of tilted surfaces which form at least one set of tilted surface,
said plurality of tilted surfaces being tilted more mildly as away from an operator of said input unit.

14. A private view protector comprising an upper surface cover shielding from above an input device entering confidential information, wherein
said upper surface member has a plurality of tilted surfaces arranged juxtapositionally to form an opening region between adjacent ones of said plurality of tilted surfaces which form at least one set,
said plurality of tilted surfaces being tilted more mildly as away from an operator of said input unit, said opening being open toward the operator of said input unit.
